(19) United States
(12) Patent Application Publication
(10) Pub. No.: US 2024/0034443 A1
(43) Pub. Date: Feb. 1, 2024

(54) OFFSHORE CHARGING STATION

(71) Applicant: Kamil Podhola, Liberec (CZ)

(72) Inventor: Kamil Podhola, Liberec (CZ)

(21) Appl. No.: 17/878,889

(22) Filed: Aug. 1, 2022

(51) Int. Cl. B63B 35/44; B60L 53/30; B60L 53/14; B60L 53/12; B63B 27/30; B60L 53/80; G06Q 20/10; G06Q 20/32; G06Q 20/34; H01M 10/44; H01M 10/42; H01M 8/04082

(52) U.S. Cl. CPC B63B 35/44; B60L 53/30; B60L 53/14; B60L 53/12; B63B 27/30; B60L 53/80; G06Q 20/10; G06Q 20/322; G06Q 20/34; H01M 10/44; H01M 10/425; H01M 8/04201; B63B 2035/448; B63B 2035/4466; B63B 2035/446; B63B 2035/4453; B60L 2200/32; H01M 2220/20; H01M 2010/4271; H01M 2010/4278; H01M 2250/20

(57) ABSTRACT

The invention relates to an offshore charging station (OCS) for water vessels at least partially electrically driven comprising one or more chargers with one or more charging interfaces for wired/wireless static/dynamic charging/discharging and supported by various supporting constructions. The OCS may further comprise charging interface mounts, marine engineering constructions, facilities, operational security control elements, thermal management systems, marine attachments, payment terminals. The OCS may be part of a cloud-based communication system, a hydrogen powering system, a marine fuelling system, a marine rechargeable power source system comprising a rechargeable power source, a source management system, a buoyant or a nonbuoyant container, a charging interface, a mobility device, a payment terminal, a thermal management system, a power source. The OCS and the marine rechargeable power source may provide data transmissions and may be provided in a modular system. An offshore swapping method using the marine rechargeable power source is proposed.

This application claims the benefit and priority of International Application No. PCT/IB2021/050161, filed 11 Jan. 2021 (11 Jan. 2021) and is hereby incorporated by reference in its entirety.

### TECHNICAL FIELD

The invention relates to a wired/wireless static/dynamic offshore charging station for water vessels at least partially electrically driven.

### BACKGROUND ART

There is a wide range of water vessels at least partially electrically driven which are gaining popularity and are becoming more available for a wider range of consumers. They may comprise a rechargeable power source. They may have an improved ecological impact and may be a sustainable form of marine transportation. Many people and companies are attracted to them because they want to decrease their personal impact on the environment through transport.

US 2020/406765 A1 (MIKALSEN JAN [US]) 31 Dec. 2020 (2020 Dec. 31) (hereinafter “MIKALSEN”) discloses a marine vessel, system, and process provided for reducing or eliminating fuel consumption and emissions of marine vessels. System and method for charging an electricity storage element of an energy storage system of a floating marine vessel may include applying a power source from a marine platform to an electrical power bus of the floating vessel to charge the electricity storage element. A power generator of the marine vessel configured to supply electrical power to the power bus may be configured from an ON state to an OFF state.

The document mainly fails to disclose an offshore charging station comprising facilities in the sense of the word as claimed in the present invention. The document further fails to disclose an offshore charging station comprising level adjustable floats, level adjustable bottom rest supporting constructions, dynamic arms and dynamic mounts as tought in the present invention, marine engineering constructions, operation security elements, thermal management systems, marine attachments, payment terminals, cloud-based communication systems, marine fuelling systems and other claimed features. The document fails to disclose offshore swapping and servicing methods.

US 2019/0317235 A1 (LYSSY MATTHEW ERIC [US]) 17 Oct. 2019 (2019 Oct. 17) discloses an example system comprising autonomous submarines and an auxiliary station including a power supply. Each autonomous submarine can include a respective power supply and a respective marine survey node coupled thereto. The auxiliary station can be configured to dock the autonomous submarines in a body of water and recharge the respective power supply of each of the autonomous submarines via the power supply of the auxiliary station. Each autonomous submarine can be configured to autonomously navigate from and return to the auxiliary station and position the respective marine survey node on an underwater surface.

The document fails to disclose features as described ad MIKALSEN.

US20140290233 (Hine et al.) discloses an improved nautical craft that can travel and navigate their own. A hybrid vessel is described that converts wave motion to locomotive thrust by mechanical means, and also converts wave motion to electrical power for storage in a battery. The electrical power can then be tapped to provide locomotive power during periods where wave motion is inadequate and during deployment. The electrical power can also be tapped to even out the undulating thrust that is created when locomotion of the vessel powered by wave motion alone.

The document fails to disclose features as described ad MIKALSEN.

WO2018214231 (Wilson) discloses a multi-functional LNG floating power generation device which can be applied to river and lake sea coastal or deep sea and can supply power to a large platform or an offshore factory of a city, an industrial area and a deep sea-sea operation on the premise that the construction of the natural gas power plant is limited by the laying of the natural gas pipeline network and temporarily does not utilize the waterarea resource development floating type of power generation device in the prior art; LNG power generation is carried out on the wharf, pipeline network laying is omitted, and the manufacturing cost is low.

The document fails to disclose features as described ad MIKALSEN.

JP2016100970 (Banatsukeisoku) discloses a power generation device installed in the sea or in water to generate electric power using the water flow energy of the tidal current or ocean current of the sea, use the generated electric power for battery charging, use the electric power for battery charging, use the electric power as a fuel source to be carried by a hydrogen fuel cell or a hydrogen engine, use electric power for charging of a battery, and store electric power in the form of a battery, and to provide a vehicle, a factory, and a ship. To provide a power generating facility in a sea area, which can be easily used in a fishery industry facility and at home, and in which a large amount of produced hydrogen gas and a battery can be easily transported on the sea. To provide a clean power generation facility using renewable energy capable of generating power without using any organic matter, capable of generating power without generating carbon dioxide, and capable of being immediately used for production of hydrogen gas and battery charge as fuel friendly to environment where no carbon dioxide gas is generated by using generated electric power, and storing and carrying electric energy. The invention relates to a technique capable of being stored and provided at a low cost.

The document fails to disclose features as described ad MIKALSEN. The term “power generation facility” as used in Banatsukeisoku does not correspond to the “facilities” as defined in the present invention.

CN 203793585 U DALIAN UNIVERSITY OF TECHNOLOGY (DALIAN) discloses an offshore green passenger transport system belongs to a passenger transport system utilizing offshore wind energy, wave energy and solar power generation to drive the offshore passenger transport ship. According to the offshore green passenger transport system, a solar power generation device and a wind energy power generation device are arranged on the multifunctional power generation platform deck, a wave energy power generation device is arranged at the bottom of the multifunctional power generation platform, each power generation device charges a ship storage battery, and the electric power drive ship storage battery is supplied to the electric power ship through a grams. According to the passenger transport system, multiple energy collection devices are arranged by utilizing the multifunctional power generation platform, and natural energy is converted into electric energy storage for use by offshore passenger transport ships.

The document fails to disclose features as described ad MIKALSEN.

### DISCLOSURE OF INVENTION

The aforementioned deficiencies are therefore solved by the features of claims 1, 14 and 15. In the dependent claims advantageous developments of the offshore charging station according to the invention are given.

It is therefore the object of the present invention to propose an offshore charging station (OCS) for water vessels at least partially electrically driven comprising one or more chargers with one or more charging interfaces for wired/wireless charging/discharging and supported by various supporting constructions, and further comprising a defined facility.

A further object is to propose the OCS enabling static/dynamic wireless charging/discharging using a defined wireless charging system.

A further object is to propose the OCS further comprising a defined charging interface mount.

A further object is to propose the OCS further comprising a defined marine engineering construction.

A further object is to propose the OCS further comprising a defined operational security control element.

A further object is to propose the OCS further comprising a defined thermal management system.

A further object is to propose the OCS further comprising a defined marine attachment.

A further object is to propose the OCS further comprising a defined payment terminal.

A further object is to propose the OCS provided in an offshore charging system and coupled by an offshore power cable with a defined power source.

A further object is to propose the OCS providing data transmissions.

A further object is to propose the OCS provided in a cloud-based communication system.

A further object is to propose the OCS in a hydrogen powering system comprising a hydrogen production system and a hydrogen storage system.

A further object is to propose the OCS in a marine fuelling system comprising a fuel dispenser, a fuel storage system and a fuelling line system.

A further object is to propose an offshore swapping method.

A further object is to propose an offshore servicing method.

Other and further objects will be explained hereinafter and will be particularly pointed out in the appended claims.

In a first aspect, the invention discloses an offshore charging station providing charging/discharging for water vessel at least partially electrically driven and further comprising defined facilities.

In a second aspect, the invention discloses an offshore swapping method using the above described offshore charging stations.

In a third aspect, the invention discloses an offshore servicing method providing a facility service and charging/discharging the water vessel at least partially electrically driven.

### BRIEF DESCRIPTION OF DRAWINGS

The invention will now be described by way of example. Only essential elements of the invention are schematically shown and not to scale to facilitate immediate understanding, emphasis being placed upon illustrating the principles of the invention.

FIG. 1 is a schematic cross sectional view of an embodiment of an offshore charging station comprising marine attachments, providing combined facilities and provided in an offshore charging system.

FIG. 2 is a schematic side view of an offshore charging station supported by a level adjustable float and comprising various facilities and provided in an offshore charging system comprising an offshore power cable coupled with an offshore power source.

FIG. 3 is a schematic side view of an offshore charging station supported by a bottom rest supporting construction and comprising marine engineering constructions, multiple facilities, a dynamic arm and a dynamic mount and provided in an offshore charging system comprising an offshore power cable coupled with an offshore power source and with an offshore wind energy to electric energy converter and a marine rechargeable power source system comprising the wind energy to electric energy converter.

FIG. 4 is a schematic side view of an offshore charging station supported by a level adjustable bottom rest supporting construction and comprising marine engineering constructions, marine rescue facilities, a robotic arm and a drone and provided in an offshore charging system comprising an offshore power cable coupled with an onshore power source and with an offshore fuel cell and the OCS is further provided in a hydrogen powering system comprising a hydrogen production system and a hydrogen storage system and further provided in a marine fuelling system comprising a hydrogen fuel dispenser, a hydrogen fuel storage system and a hydrogen fuelling line system.

FIG. 5 is a schematic side view of an offshore charging station supported by a float and comprising a marine engineering construction, a shopping facility, operational security control elements, a payment terminal, and provided in an offshore charging system comprising an offshore power cable coupled with an onshore power source and provided in a marine fuelling system comprising a fuel dispenser, a fuel storage system and a fuelling line system.

FIG. 6 is a schematic of an offshore charging station provided in a cloud-based communication system comprising communication nodes being the offshore charging station, a water vessel at least partially electrically driven, a marine rechargeable power source and an operator.

FIG. 7 is a schematic side view of an offshore charging station supported by a moored float and comprising marine engineering constructions, recreational facilities and provided in an offshore charging system comprising an offshore power cable coupled with an onshore power source.

FIG. 8 is a schematic side view of another embodiment of an offshore charging station supported by level adjustable floats and comprising marine engineering constructions, shopping and recreational facilities and provided in an offshore charging system comprising an offshore power cable coupled with an onshore power source.

FIG. 9 is a schematic side view of another embodiment of an offshore charging station supported by a float and comprising marine engineering constructions, a maritime rescue facility and provided in an offshore charging system comprising an offshore power cable coupled with an onshore power source.

FIG. 10 is a schematic side view of another embodiment of an offshore charging station supported by anchored floats and comprising marine engineering constructions, various facilities and provided in an offshore charging system comprising an offshore power cable coupled with an onshore power source.

FIG. 11 is a schematic side view of another embodiment of an offshore charging station supported by a bottom rest supporting construction and comprising marine engineering constructions, a shopping facility and provided in an offshore charging system comprising an offshore power cable coupled with an offshore wind energy to electric energy converter.

FIG. 12 is a schematic side view of another embodiment of an offshore charging station similar to that shown in FIG. 11 provided in an offshore charging system comprising an offshore power cable coupled with an offshore array of solar cells.

FIG. 13 is a schematic side view of another embodiment of an offshore charging station similar to that shown in FIG. 11 provided in an offshore charging system comprising an offshore power cable coupled with a wave energy to electric energy converter, a tidal energy to electric energy converter and a water current energy to electric energy converter.

FIG. 14 is a schematic side view of another embodiment of an offshore charging station supported by an anchored float and comprising marine engineering constructions, recreational facility and a wired and a wireless charger configured to enable static wireless charging and/or discharging and provided in an offshore charging system comprising an offshore power cable coupled with an offshore power source.

FIG. 15 is a schematic side view of another embodiment of an offshore charging station similar to that shown in FIG. 14 comprising wireless charging interfaces and configured to enable dynamic wireless charging and/or discharging.

FIG. 16 is a schematic oblique view of a marine rechargeable power source comprising a rechargeable power source, a source management system, a nonbuoyant mobile container, a charging interface, a payment terminal, a thermal management system and an array of solar cells.

FIG. 17 is a schematic oblique view of a marine rechargeable power source comprising a rechargeable power source, a source management system, a mobile buoyant container, a charging interface, a power transfer interface, a power cable, a payment terminal, a thermal management system and an array of solar cells.

FIG. 18 is a schematic side view of a marine rechargeable power source comprising a rechargeable power source, a source management system, a mobile buoyant container, a charging interface, a payment terminal and a thermal management system.

FIG. 19 is a schematic of a first step of an offshore swapping method, the step of bringing by water vessels at least partially electrically driven first marine rechargeable power sources—one buoyant and the other nonbuoyant—within an operational range of an offshore charging station comprising facilities.

FIG. 20 is a schematic of a second step of the offshore swapping method shown in FIG. 19, the step of swapping the first marine rechargeable power sources for second marine rechargeable power sources—one buoyant and the other nonbuoyant—provided by the offshore charging station comprising facilities.

FIG. 21 is a schematic of a third step of the offshore swapping method shown in FIGS. 19 and 20, the step of transferring power between the rechargeable power sources and the water vessels at least partially electrically driven while in a motion.

FIG. 22 is a perspective illustration of another embodiment of a designed offshore charging station comprising recreational facilities.

FIG. 23 is a side view of another embodiment of a hull-type designed offshore charging station comprising accomodation/recreational facilities.

FIG. 24 is a perspective view of another embodiment of a float-type designed offshore charging station comprising work-shop/recreational facilities.

FIG. 25 is a perspective view of another embodiment of a designed offshore charging station comprising recreational facilities.

FIG. 26 is a cross sectional elevation view of another embodiment of a modular offshore charging station comprising recreational facilities.

FIG. 27 is an interior perspective view of another embodiment of an offshore charging station comprising shopping/recreational facilities.

FIG. 28 is a perspective illustration of another embodiment of a designed offshore charging station comprising shopping facilities.

FIG. 29 is a perspective illustration of another embodiment of a designed offshore charging station comprising a prefabricated modular marine engineering construction housing shopping, recreational and accomodation facilities.

FIG. 30 is a perspective illustration of another embodiment of an offshore charging station comprising a marine engineering construction housing work-shop facilities.

FIG. 31 is a perspective illustration of another embodiment of an offshore charging station comprising a modular marine engineering construction and comprising a shopping facility.

FIG. 32 is a perspective illustration of another embodiment of an offshore charging station comprising a marine engineering construction housing shopping, recreational and accomodation facilities.

FIG. 33 is a perspective illustration of another embodiment of a polyvalent offshore charging station comprising a marine engineering construction housing various facilities.

FIG. 34 is a perspective illustration of another embodiment of a marine type designed offshore charging station comprising a marine engineering construction housing various facilities.

FIG. 35 is a perspective illustration of another embodiment of a small scale designed offshore charging station comprising a marine engineering construction and various facilities.

FIG. 36 is a perspective illustration of another embodiment of a drive thru type designed offshore charging station comprising a marine engineering construction and shopping and recreational facilities.

FIG. 37 is a schematic of another embodiment of an offshore charging station comprising shopping freezing facilities provided in an offshore charging system and providing a thermal management system including master and slave tempering loops.

FIG. 38 is a schematic side view of another embodiment of an offshore charging station comprising multiple facilities and provided in an offshore charging system and providing a thermal management system consisting of a backbone and peripheral tempering loops and using offshore water as a thermal medium.

FIG. 39 is a schematic side view of a thermal management system of an air cooled wireless charging interface of an offshore charging station comprising a facility.

FIG. 40 is a perspective illustration of a thermal management system of a liquid cooled wireless charging interface, the system using a thermal contact with an offshore water.

FIG. 41 is a schematic of a thermal management system of a charging cable which can be used in the proposed offshore charging system.

FIG. 42 is a process flowchart of an offshore servicing method.

FIG. 43 is a perspective schematic illustration of an offshore servicing method.

FIG. 44 is a perspective illustration of another embodiment of the offshore servicing method provided by a maritime multi-facility offshore charging station.

### BEST MODE FOR CARRYING OUT THE INVENTION

The following detailed description shows the best contemplated modes of exemplary embodiments. The description is made for the purpose of illustrating the general principles of the invention, and in such a detail that a skilled person in the art can recognise the advantages of the invention, and can be able to make and use the invention. The detailed description is not intended to limit the principle of the presented invention, but only to show the possibilities of it.

The terms used in the claims and the specifications shall refer to their synonyms as well.

The term “inductive” shall also refer to resonant inductive, the term “capacitive” shall also refer to resonant capacitive.

The term “magnetodynamic” shall preferably not exclusively refer to magneto-mechanical systems using translational and/or rotational motion of a magnetic element or arrays of magnetic elements to wirelessly transfer power.

The term “to couple” and derivatives shall refer to a direct or indirect connection via another device, connection, element, and the like.

The term “to support” and derivatives shall refer to a direct or indirect supporting function via another device, structure, element, and the like.

As used in the claims and the specification, the term “water vessel at least partially electrically driven” shall refer to manned and unmanned water vessels, and shall refer to overwater and underwater water vessels, and shall refer to toys and models and the like as well.

As used in the claims and the specification, the terms “float”, “level adjustable float” shall preferably not exclusively refer to an anchored float wherein said anchoring may be selected from the group consisting of static anchoring (e.g. with anchoring lines), dynamic anchoring, or combinations thereof, (the same applies to mooring, tethering, etc.) and shall further refer to any construction providing a charging station and/or a charging interface with buoyancy and shall refer to passive buoyancy control systems and active buoyancy control systems wherein flotation may be obtained by various active devices (variable ballast tanks, compressed air, propellers, jets, etc.), shall refer to combined systems and shall refer to built-in, attached, detachably attached, etc. floats in various configurations.

As used in the claims and the specification, the term “bottom rest supporting construction”, “level adjustable bottom rest supporting construction” shall preferably not exclusively refer to a bottom rest supporting construction, wherein at least one said bottom rest supporting construction is selected from the group consisting of fixed constructions, compliant constructions, or combinations thereof.

As used in the claims and the specification, the term “level” as in “level adjustable float”, “level adjustable bottom rest supporting construction” shall preferably not exclusively refer to a level wherein at least one said level is selected from the group consisting of levels situated between above water level and a water bottom, or combinations thereof.

As used in the claims and the specification, the term “level adjustable”, shall preferably not exclusively refer to mechanical (e.g. sliding constructions, slack-line configurations), hydraulical, electromagnetical, pneumatic constructions, and shall refer to constructions powered manually, electrically, hydraulically, pneumatically, and shall refer to constructions powered by natural forces, e.g. buoyant force, gravitation force, etc., and shall refer to constructions controlled manually, computer controlled, remote controlled, natural phenomena controlled (e.g. controlled by tides), etc.

As used in the claims and the specification, the terms “onshore power source”, “offshore power source” shall refer to power transmission systems, power distribution systems and shall refer to mobile systems and shall refer to “power grid” and the like as well.

As used in the claims and the specification, the term “motor generator” shall preferably not exclusively refer to electric energy generating systems using an electrical generator coupled with an engine (which can be a jet engine, an engine burning a hydrocarbon fuel, a gas generator, a turbine, etc.) and shall also refer to the term “power plant”, and the like, and shall also refer to mobile units, compact units, enclosed units, portable units, skid mounted units and shall also refer to thermal electric types and atomic types and shall also refer to floating and underwater types and shall also refer to power plants, power units comprising exhaust products (e.g. gases, fluids) treatments.

As used in the claims and the specification, the term “rechargeable power source” shall refer to rechargeable batteries, capacitors, hybrid sources, energy storage elements, and the like.

As used in the claims and the specification, the terms “mobile container”, “buoyant container”, “mobile buoyant container” shall refer to any type of containers with built-in, attached, detachably attached, etc. devices providing the containers with mobility, respective buoyancy.

As used in the claims and the specification, the term “fuel” as in the marine fuelling system shall refer to any type of marine fuel, preferably not exclusively to hydrogen gases, hydrogen liquids, compressed natural gases, liquefied natural gases, biofuels, low sulphur fuel oils, emulsified fuels, methanols, including mixture type fuels.

As used in the claims and the specification, the singular forms are intended to include the plural forms as well.

As used in the claims and the specification, “A/B” shall refer to A and/or B.

The terms “to comprise”, “to include”, “to contain” and derivatives specify the presence of an element, but do not preclude the presence or addition of one or more other elements or groups and combinations thereof.

The term “consisting of” characterises a Markush group which is by nature closed. Single members of the group are alternatively useable for the purpose of the invention. Therefore, a singular if used in the Markush group would indicate only one member of the group to be used. For that reason are the countable members listed in the plural. That means together with qualifying language after the group “or combinations thereof” that only one member of the Markush group can be chosen or any combination of the listed members in any numbers. In other words, although elements in the Markush groups may be described in the plural, the singular is contemplated as well. Furthermore, the phrase “at least one” preceding the Markush groups is to be interpreted that the group does not exclude one or more additional elements preceded by the phrase.

The invention will be described in reference to the accompanying drawings.

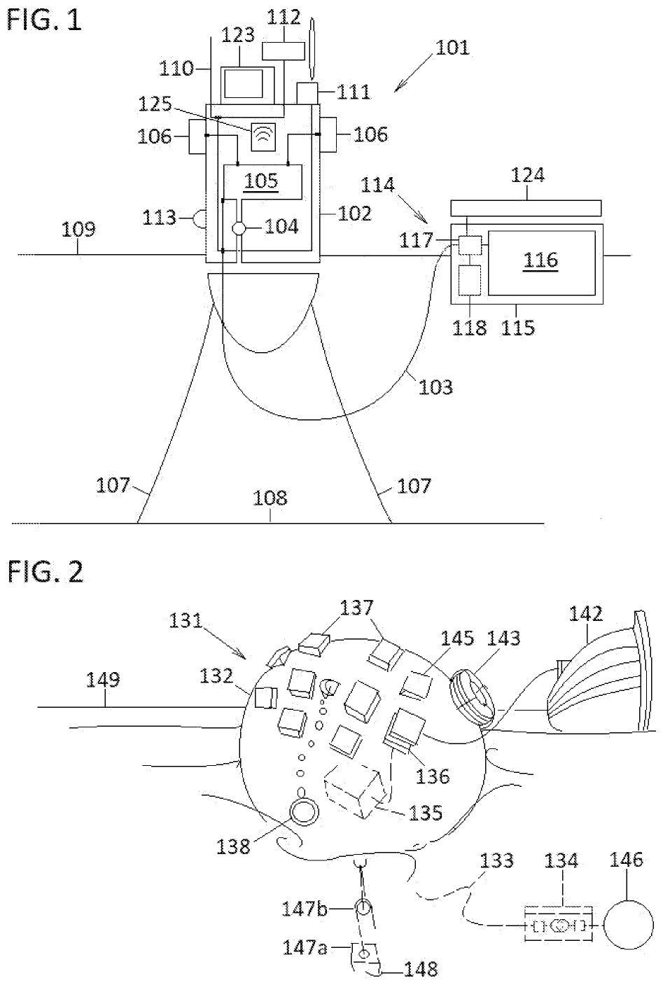

FIG. 1 is a schematic cross sectional view of an offshore charging station (101) supported by an anchored float (102) and comprising marine attachments (110, 111, 112, 113) and a facility (123) and provided in an offshore charging system comprising an offshore power cable (103) coupled with an offshore array of solar cells (124) and a marine rechargeable power source system (114) comprising the array of solar cells (124).

The offshore charging station (101) can comprise a charger (105) [which can be an AC charger, a DC charger, an inductive charger, a capacitive charger, a magnetodynamic charger, or any combinations thereof]. The charger can be coupled with one or more charging interfaces (106).

The anchored float (102) can be fabricated from any convenient material and use any anchoring system (107) attaching the OCS (101) to a water bottom (108) under water level (109) [and/or it can use any mooring system including dynamic mooring (not shown)]. The marine attachments can be an antenna (110), a navigational aid construction (111), a recording instrument (112) and a mooring attachment (113). The facility (123) can be an automatic case providing a marine workshop equipment. The charger (105) and the facility (123) can be coupled with a payment terminal (125) [which can enable contactless card and mobile payments]. The charging station (101) can comprise a thermal management system (104) [which can be a liquid tempering system using offshore water as a thermal medium] managing charging/discharging [e.g. cooling the charger (105), charging cables and charging interfaces (106)].

The marine attachments (110, 111, 112, 113) and the charger (105) can be coupled with the offshore power cable (103) which can be coupled [as a power cable to transfer power] with a marine rechargable power source system (114) which can comprise a buoyant container (115), which can support the array of solar cells (124) [which can be a solar panel], and contain a rechargeable power source (116) [which can be banks of rechargeable capacitors and/or batteries] which can be coupled with a power flow regulator (117) which can be controlled by a programmable controller (118) [which can include a processor, a memory and a communication unit]. The power flow regulator (117) and the controller (118) can perform a function of a source management system or it can be one or more separate units in various topologies.

FIG. 2 is a schematic perspective illustration of another embodiment of the offshore charging station (131) supported by a level adjustable floater (132) and provided in an offshore charging system comprising an offshore power cable (133) coupled with an offshore power source (134) [e.g. a smart substation]. The charging station (131) can comprise an operational security element (138) [e.g. a control element operable to interrupt power supply]. The smart substation (134) can be further controlled by a central controller (146).

The offshore charging station (131) can comprise a charger (135) [which can be an AC charger, a DC charger, an inductive charger, a capacitive charger, a magnetodynamic charger, or any combinations thereof]. The charger (135) can be coupled with one or more charging interfaces (136) [which can be watertight wired connections or wireless charging interfaces]. The charging station can comprise a mooring attachement (143), facilities (not shown) providing services [e.g. an automated food shop, beverages shop, marine supplies shop, charging equipment shop, the Internet connection, etc.] operable by user interfaces (137) [which can be buttons, radio frequency identification (RFID) readers providing card or mobile app payments, etc.]. The charging/discharging and facilities's services can be paid for by means of a (contactless) payment terminal (145). The level adjustable floater (132) can be fabricated from any convenient material and use any anchoring system (147a) attaching the OCS (131) to a water bottom (148) under water level (149) [e.g. by means of an anchoring line and a suitable mechanism (147b) (e.g. electrical, hydraulical, mechanical) to level adjust the float (132), e.g. to pull the floater (132) under the water level (149) in case of a squall]. A dynamic anchoring system (not shown) can be used instead which can use any type of position sensors (not shown) and active propelling systems to maintain the position, orientation, to couple with water currents, to drive the station (131) into a port to be serviced, etc. A water vessel at least partially electrically driven (142) can be coupled in a bidirectional power flow with the charging interface (136) and become temporarily a part of the system.

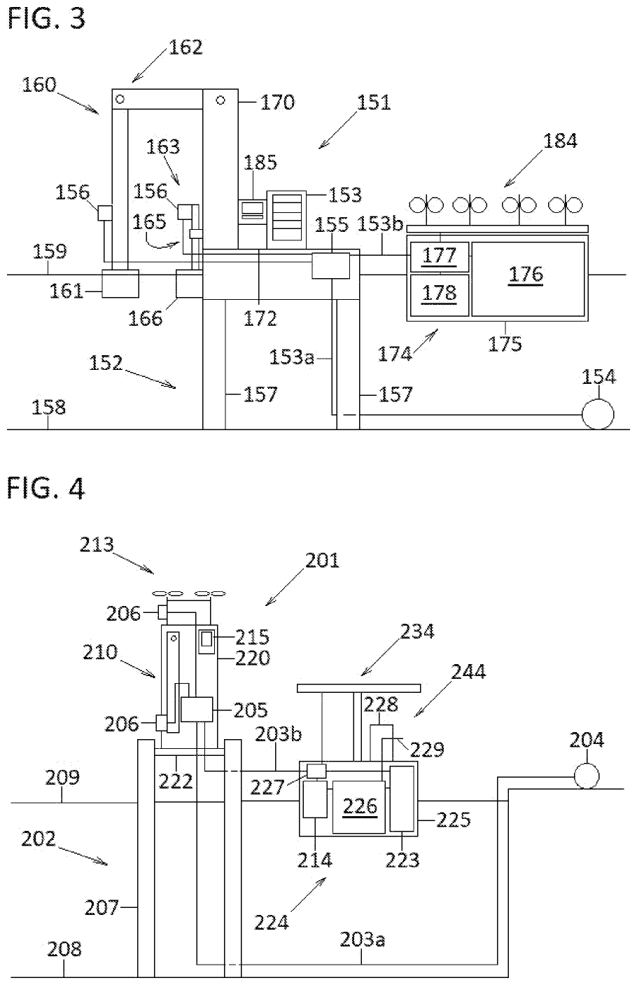

FIG. 3 is a schematic side view of an offshore charging station (151) supported by a bottom rest supporting construction (152) and comprising marine engineering constructions (170, 172), a dynamic arm (160) and a dynamic mount (163) and provided in an offshore charging system comprising an offshore power cable (153a) coupled with an offshore power source (154) and another offshore power cable (153b) coupled with an offshore wind energy to electric energy converter (184) and a marine rechargeable power source system (174) which can comprise a buoyant container (175), which can support the wind energy to electric energy converter (184), and contain a rechargeable power source (176) [which can be banks of rechargeable capacitors and/or batteries] a power flow regulator (177) which can be controlled by a programmable controller (178).

The offshore charging station (151) can comprise a charger (155) [which can be an AC charger, a DC charger, an inductive charger, a capacitive charger, a magnetodynamic charger, or any combinations thereof]. The charger (155) can be coupled with one or more charging interfaces (156). Charging interface mounts can be the dynamic arm (160) [which can be supported by a float (161) coupled with a rotating mechanism (162) which can cope with tidal and wave changes] and the dynamic mount (163) [which can similarly be supported by a float (166) coupled with a movable mechanism (165)] which can be able to delocalize the interfaces to enable charging and/or discharging. The charging interface mounts (160, 163) can be coupled with a column (170) which can be supported by a platform (172) on the bottom rest supporting construction (152) which can be of any type of a supporting construction (157) attaching the OCS to a water bottom (158) under water level (159).

The charging station (151) can comprise facilities (153) providing services [e.g. an automated food shop, a marine equipment shop, the Internet access, etc., which can be equipped with a central payment terminal (185) processing payments for the services including charging/discharging [discharging payments mean that the charging station (151) can pay to an user for supplied electricity].

FIG. 4 is a schematic side view of an offshore charging station (201) supported by a level adjustable bottom rest supporting construction (202) and comprising marine engineering constructions (220, 222), a robotic arm (210) and a drone (213). The charging station (201) can comprise marine rescue facilities (213) [e.g. the charging drone (213) can provide marine monitoring functions]. The charging/discharging and facilities's services can be paid for by means of a (contactless) payment terminal (215).

The offshore charging station (201) can be provided in an offshore charging system comprising an offshore power cable (203a) coupled with an onshore power source (204) [which can be an onshore power grid] and another offshore power cable (203b) coupled with an offshore fuel cell (214) and with an offshore array of solar cells (234) [which can be a solar panel] wherein the OCS can be provided in a hydrogen powering system (224) comprising a hydrogen storage system (226) [which can be a container (high pressurised, cryo-compressed, cryogenically liquefied, solid state physical storage/chemical storage) of various shapes and dimensions (e.g. cylindric, cubic) and from various materials (e.g. metals, composites, glass)] and a hydrogen production system (223) [which can be an acidic, alkaline, solid oxide, photo, photo-electrochemical electrolysis systems, hydrocarbons reforming systems, alcohols reforming systems, sugars reforming systems, chemical processing systems, biological processing systems, biomass processing systems, thermal processing systems, photo processing systems, metal and water systems].

The OCS (201) can be further provided in a marine fuelling system (244) which can comprise a hydrogen fuel dispenser (228) and a hydrogen fuelling line system (229) wherein the hydrogen storage system (226) can be part of a hydrogen fuel storage system (226). The hydrogen storage system (226) can be coupled with the fuel cell (214) which can use hydrogen to generate power which can be used by the OCS (201).

The offshore charging station (201) can comprise a charger (205) [which can be a wired and/or wireless charger]. The charger (205) can be coupled with one or more charging interfaces (206). Charging interface mounts can be the robotic arm (210) (or a robot) and the drone (213) [which can be any type of the drone] which can be able to delocalize the interfaces (206) to enable charging and/or discharging. The charging interface mounts (210, 213) can be coupled with a column (220) which can be supported by a platform (222) on the level adjustable bottom rest supporting construction (202) which can be of any type of a supporting construction (207) [e.g. a fixed construction which can comprise a suitable mechanism (e.g. electrical, hydraulical, mechanical) to level adjust the platform (222)] attaching the OCS (201) to a water bottom (208) under water level (209). The charger (205) can be coupled with the offshore power cables (203a, 203b).

The hydrogen powering system (224), the fuelling system (244), the fuel cell (214), the array of solar cells (234) can be supported by a buoyant and/or bottom rest supporting construction [e.g. a buoyant container (225) which can further contain a power flow regulator (227) which can be coupled with the fuel cell (214), the hydrogen production system (223) and the offshore array of solar cells (234)].

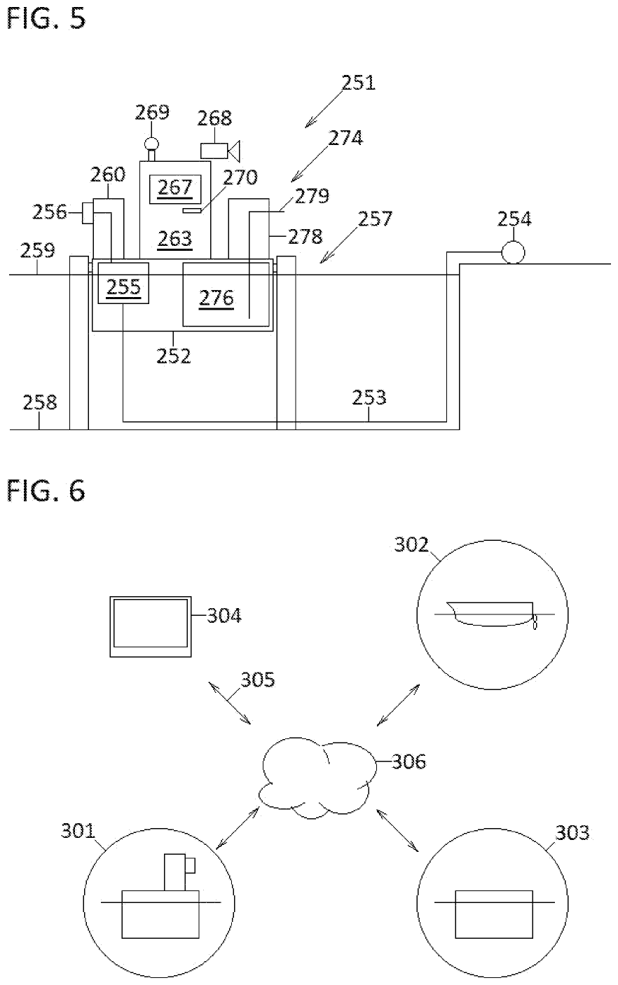

FIG. 5 is a schematic side view of an offshore charging station (251) supported by a float (252) and comprising a marine engineering construction (263), a facility (267), operational security control elements (268, 269), a payment terminal (270), and provided in an offshore charging system comprising an offshore power cable (253) coupled with an onshore power source (254) and provided in a marine fuelling system (274) comprising a fuel dispenser (278), a fuel storage system (276) [which can be a fuel tank, cylinder, container] and a fuelling line system (279).

The offshore charging station (251) can comprise a charger (255) [which can be a wired and/or wireless charger]. The charger (255) can be coupled with a charging interface (256). A charging interface mount can be a static mount (260) [which can be a charging column] which can hold the interface (256) in a position. The float (252) can be fabricated from any convenient material and use any anchoring system (257) [e.g. a sliding system] attaching the OCS (251) to a water bottom (258) under water level (259). The OCS (251) can comprise a wall (263) which can support the facility (267) operable at the OCS [which can be a shopping facility, e.g. a vending machine], the operational security control elements [which can be a security camera (268) with a security control circuit including a burglar alarm (269)], and the payment terminal (270) [which can enable online payments, cash payments, mobile payments, chip card payments, and/or magnetic stripe card payments]. The charger (255) can be coupled with the offshore power cable (253) via a control element operable to interrupt power supply (not shown) [which can be a remotely controlled switch]. The OCS can be provided in a marine fuelling system (274) wherein the fuelling line system (279) can transfer a marine fuel from the fuel storage system (276) to the fuel dispenser (278).

FIG. 6 is a schematic of an offshore charging station (301) provided in a cloud-based communication system comprising communication nodes which can be the offshore charging station (301), a water vessel at least partially electrically driven (302), a marine rechargeable power source (303) and an operator (304).

The communication nodes can be in wired and/or wireless communication (305) with a cloud (306) which can store their data. The operator (304) can via the cloud (306) operate the communication system. Each communication node (301, 302, 303, 304) and the cloud (306) can have a different operator. There can be a plurality of clouds, some for facilities provided by respective charging stations (301) (not shown) and others for the charging management.

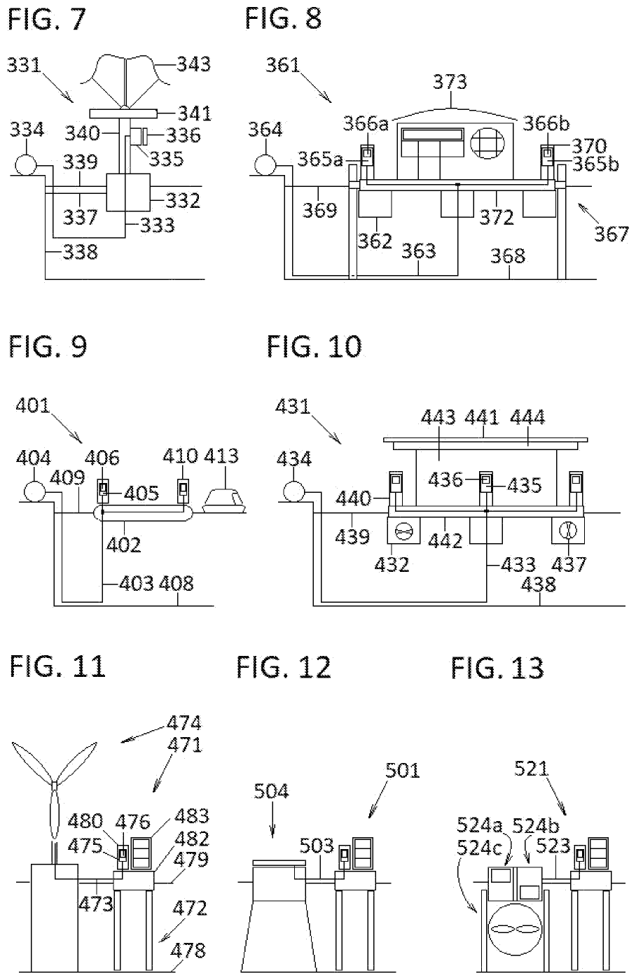

FIG. 7 is a schematic side view of an offshore charging station (331) supported by a moored float (332) and comprising marine engineering constructions (340, 341) and provided in an offshore charging system comprising an offshore power cable (333) coupled with an onshore power source (334).

The offshore charging station (331) can comprise a charger (335) [which can be a wired and/or wireless charger]. The charger (335) can include a charging interface (336). The charger (335) can be coupled with a column (340) which can support a roof (341). The charging station (331) can comprise recreational facilities (343) [e.g. a foldable canopy]. The moored float (332) can be fabricated from any convenient material and use any mooring system (337) [e.g. mooring lines] attaching the OCS to a quay wall (338) [or any onshore/offshore mooring point] at about a water level (339). The charger (335) can be coupled with the offshore power cable (333).

FIG. 8 is a schematic side view of another embodiment of an offshore charging station (361) supported by level adjustable floats (362) and comprising marine engineering constructions (370, 372) and provided in an offshore charging system comprising an offshore power cable (363) coupled with an onshore power source (364).

The offshore charging station (361) can comprise chargers (365a, 365b) [which can be wired and/or wireless chargers] which can include charging interfaces (366a, 366b) and can be built in columns (370) which can be supported by a platform (372). The level adjustable floats (362) can be attached to a water bottom (368) under water level (369) [e.g. by means of sliding constructions (367) which can comprise a suitable mechanism (e.g. electrical, hydraulical, mechanical) to level adjust the floats (362)]. The chargers (365a, 365b) can be coupled with the offshore power cable (363). The charging station (361) can comprise shopping and recreational facilities (373) [e.g. a coffee shop, a fast food restaurant, a food shop, a restaurant with or without a table service, etc.].

FIG. 9 is a schematic side view of another embodiment of an offshore charging station (401) supported by a float (402) and comprising marine engineering constructions (410) and provided in an offshore charging system comprising an offshore power cable (403) coupled with an onshore power source (404).

The offshore charging station (401) can comprise chargers (405) [which can be wired and/or wireless chargers] which can include charging interfaces (406). The chargers (405) can be coupled with columns (410) which can be mounted directly on the float (402) which can be provided at about water level (409) above water bottom (408). The chargers (405) can be coupled with the offshore power cable (403). The charging station (401) can comprise a maritime rescue facility (413) [e.g. provide a lifeboat, etc.].

FIG. 10 is a schematic side view of another embodiment of an offshore charging station (431) supported by anchored floats (432) and comprising marine engineering constructions (440, 441, 442, 443) and provided in an offshore charging system comprising an offshore power cable (433) coupled with an onshore power source (434).

The offshore charging station (431) can comprise chargers (435) which can include charging interfaces (436). The chargers (435) can be attached to columns (440) which can be mounted on a platform (442) which can further support a marine building which can comprise a wall (443), a roof (441) supported by a beam (444) and which can provide facilities operables at the OCS (431) [which can be maritime rescue facilities, shopping facilities, work-shop facilities, recreational facilities, accommodation facilities, e.g. a maritime hotel]. The platform (442) can be supported by anchored floats (432) which can use a dynamic anchoring system (437) [which can anchor and relocate the OCS (431); an alternative dynamical anchoring can be provided by one or more water vessels (not shown) which can bear a power source coupled to the OCS with an offshore power cable (not shown)]. The platform (442) can be provided at about water level (439) above water bottom (438). The chargers (435) can be coupled with the offshore power cable (433).

FIG. 11 is a schematic side view of another embodiment of an offshore charging station (471) supported by a bottom rest supporting construction (472) and comprising marine engineering constructions (480, 482) and provided in an offshore charging system comprising an offshore power cable (473) coupled with an offshore wind energy to electric energy converter (474).

The offshore charging station (471) can comprise a charger (475) which can include a charging interface (476). The charger (475) can be coupled with a column (480) which can be mounted on a platform (482) supported by the bottom rest supporting construction (472) which can attach the OCS (471) to a water bottom (478) under water level (479). The charger (475) can be coupled with the offshore power cable (473). The OCS (471) can comprise facilities (483) [which can be an air conditioned sea fruits vending machine].

FIG. 12 is a schematic side view of another embodiment of an offshore charging station (501) comprising facilities and similar to that shown in FIG. 11 provided in an offshore charging system comprising an offshore power cable (503) coupled with an offshore array of solar cells (504).

FIG. 13 is a schematic side view of another embodiment of an offshore charging station (521) comprising facilities and similar to that shown in FIG. 11 provided in an offshore charging system comprising an offshore power cable (523) coupled with a wave energy to electric energy converter (524a), a tidal energy to electric energy converter (524b) and a water current energy to electric energy converter (524c).

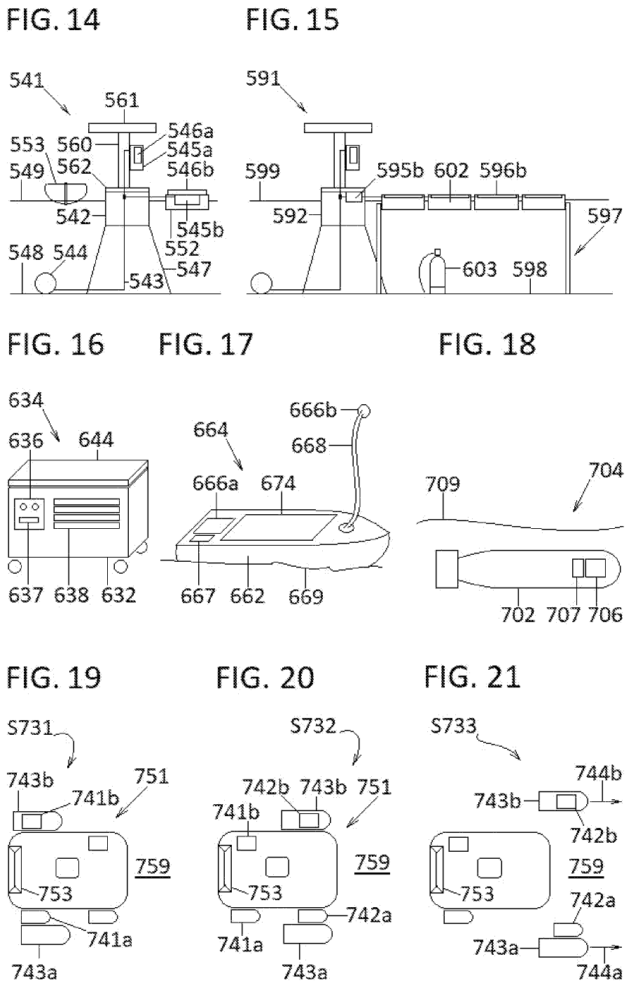

FIG. 14 is a schematic side view of another embodiment of an offshore charging station (541) supported by an anchored float (542) and comprising marine engineering constructions (560, 561, 562), a wired charger (545a) and a wireless charger (545b) [which can be an inductive charger, a capacitive charger, a magnetodynamic charger] configured to enable static wireless charging and/or discharging and provided in an offshore charging system comprising an offshore power cable (543) coupled with an offshore power source (544).

The offshore charging station (541) can comprise a charger (545a) which can include a wired charging interface (546a). The charger (545a) can be coupled with a column (560) which can support a roof (561) and can be mounted on a platform (562) mounted on the anchored float (542). The wireless charger (545b) can be mounted into a float (552) which can be fabricated from any convenient material, use any anchoring system [e.g. it can be moored to the float (542) and/or anchored to a water bottom (548)] and which can further support the wireless charging interface (546b) [which can be an inductive charging interface, a capacitive charging interface, a magnetodynamic charging interface] coupled with the wireless charger (545b). The anchored float (542) can be attached to the water bottom (548) under water level (549) [e.g. by means of anchoring lines (547)]. The chargers (545a, 545b) can be coupled with the offshore power cable (543). The charging station (541) can comprise a recreational facility (553) [e.g. a boat rental].

FIG. 15 is a schematic side view of another embodiment of an offshore charging station (591) similar to that shown in FIG. 14 comprising wireless charging interfaces (596b) and configured to enable dynamic wireless charging and/or discharging.

The wireless charger (595b) [which can be an inductive charger, a capacitive charger, a magnetodynamic charger] can be mounted into a float (592) and can be coupled with the wireless charging interfaces (596b) [which can be inductive charging interfaces, capacitive charging interfaces, magnetodynamic charging interfaces] which can be supported by level adjustable floats (602) which can be level adjustable between at about water level (599) and a water bottom (598), and which can be fabricated from any convenient material and use any anchoring system (597) [e.g. a sliding system], and which can enable dynamic charging to a water vessel (not shown) in a motion. The charging station (591) can comprise a recreational facility (603) [e.g. a scuba center].

### Common Features of FIGS. 1 to 15

Offshore charging stations (OCSs) can comprise thermal management systems to thermally manage charging and/or discharging [e.g. the systems can thermally manage the chargers and/or charging interfaces and/or charging cables] using air tempering systems, liquid tempering systems and/or liquid tempering systems using offshore water as a thermal medium. The systems can comprise ventilators, thermal exchangers, compressors, chillers, condensers, heaters, sensors, pumps, programmable controllers, thermal medium conducts, valves, etc.

The OCSs can provide wired/wireless data transmissions in relation with charging/discharging water vessels at least partially electrically driven. The data transmissions can be local [e.g. via charging interfaces, local wired/wireless networks] and distant [e.g. via offshore power cables, satellite connections, telephone techniques, etc.]. The data transmissions can include underwater acoustic techniques. The OCSs can use any type of communication interfaces, lines, techniques and protocols.

FIG. 16 is a schematic oblique view of a marine rechargeable power source (634) comprising a rechargeable power source, a source management system, a nonbuoyant mobile container (632), a charging interface (636), a payment terminal (637), a thermal management system and an array of solar cells (644).

The rechargeable power source (not shown) can be banks of rechargeable capacitors and/or batteries. The source management system (not shown) can manage charging and/or discharging of the rechargeable power source [it can comprise various circuit topologies including electrocomponents such as converters, inverters, voltage regulators, power factor corrections, rectifiers, filters, controllers, processors, etc.]. The mobile container (632) can be fabricated from any convenient material and can comprise any convenient mobile device which can be controlled by a convenient control system including a remote control. The charging interface (636) can be any type of a wired and/or wireless charging interface and the payment terminal (637) can be of any convenient type. The thermal management system (only ventilation grilles (638) shown) can be of any air and/or liquid tempering systems [it can comprise ventilators, thermal exchangers, compressors, chillers, condensers, heaters, sensors, pumps, programmable controllers, thermal medium conducts, valves]. The array of solar cells (644) can be a solar panel mounted on the container (632) and coupled with the source management system.

FIG. 17 is a schematic oblique view of a marine rechargeable power source (664) comprising a rechargeable power source, a source management system, a mobile buoyant container (662), a charging interface (666a), a power transfer interface (666b), a power cable (668), a payment terminal (667), a thermal management system and an array of solar cells (674).

The rechargeable power source (not shown) can be banks of rechargeable capacitors and/or batteries. The source management system (not shown) can manage charging and discharging the rechargeable power source. The buoyant container (662) can be fabricated from any convenient material and can comprise any convenient mobile device which can be controlled by any convenient control system including remote control. The mobile device (not shown) can be any type of jets, propellers, propelling devices, and the like.

The charging interface (666a) [to charge/discharge a water vessel at least partially electrically driven (not shown) and/or the rechargeable power source] can be any type of a wired and/or wireless charging interface, preferably waterproof. The power transfer interface (666b) can be any type of wired/wireless interface configured to transfer power between the rechargeable power source and the water vessel [which can be a traction power transfer for a traction motor of the water vessel, a power transfer for auxiliaries of the water vessel, and which can have different parameters from the charging/discharging power transfer via the dedicated charging interface (666a), alternatively the both interfaces (666a and 666b) can be provided in one combined power transfer/charging interface for a power transfer which can be used by the vessel as a charging/discharging power transfer and as the traction/auxiliary power transfer]. The power cable (668) can transfer power between the rechargeable power source and the vessel and between an external power source (not shown) and the rechargeable power source to be charged/discharged. The payment terminal (667) can be of any convenient type, e.g. contactless, and preferably waterproof.

The thermal management system can thermally manage the rechargeable power source and/or the both interfaces (666a and 666b) and/or the power cable (668) using air tempering systems, liquid tempering systems and liquid tempering systems using offshore water as a thermal medium. The liquid systems can use thermal exchangers (not shown) thermally coupled with ambient water. The array of solar cells (674) can be a solar panel mounted on the buoyant container (662) and coupled with the source management system. The marine rechargeable power source (664) can be provided in offshore water above water level (669).

FIG. 18 is a schematic side view of a marine rechargeable power source (704) comprising a rechargeable power source, a source management system, a mobile buoyant container (702), a charging interface (706), a payment terminal (707) and a thermal management system. The marine rechargeable power source (704) can be similar to that shown in FIG. 17. The container (702) can be torpedo shaped and can be able to function underwater. The mobile device can be a propeller and the charging interface (706) can be a watertight wired connection or wireless interface, preferably watertight. The payment terminal (707) can be of any convenient type. The thermal management system can be preferably a liquid tempering system and can be thermally coupled with ambient water. The marine rechargeable power source (704) can be provided in offshore water under water level (709).

### Common Features of FIGS. 16 to 18

The marine rechargeable power sources (634, 664, 704) can be configured to be a swappable power source for water vessels at least partially electrically driven [e.g. can comprise compatible interfaces (636, 666a, 666b, 706), various compatible coupling devices (not shown)/e.g. detachably attachable/, compatible communication interfaces (not shown), etc.]. Thermal management systems can thermally manage the respective rechargeable power sources and/or the power transfer interfaces (636, 666a, 666b, 706) and/or the power cable (668) using air tempering systems, liquid tempering systems and liquid tempering systems using offshore water as a thermal medium.

FIG. 19 is a schematic of a first step (S731) of an offshore swapping method, the step of bringing by water vessels at least partially electrically driven (743a, 743b) first marine rechargeable power sources (741a, 741b)—one buoyant (741a) and the other nonbuoyant (741b)—within an operational range of an offshore charging station (751) comprising facilities (753) and situated in an offshore water (759).

FIG. 20 is a schematic of a second step (S732) of the offshore swapping method shown in FIG. 19, the step of swapping the first marine rechargeable power sources (741a, 741b) for second marine rechargeable power sources (742a, 742b)— one buoyant (742a) and the other nonbuoyant (742b)—provided by the offshore charging station (751) in the offshore water (759).

FIG. 21 is a schematic of a third step (S733) of the offshore swapping method shown in FIGS. 19 and 20, the step of transferring power between the second marine rechargeable power sources (742a, 742b) and the water vessels at least partially electrically driven (743a, 743b) while in a motion (744a, 744b) [or stationary] in the offshore water (759).

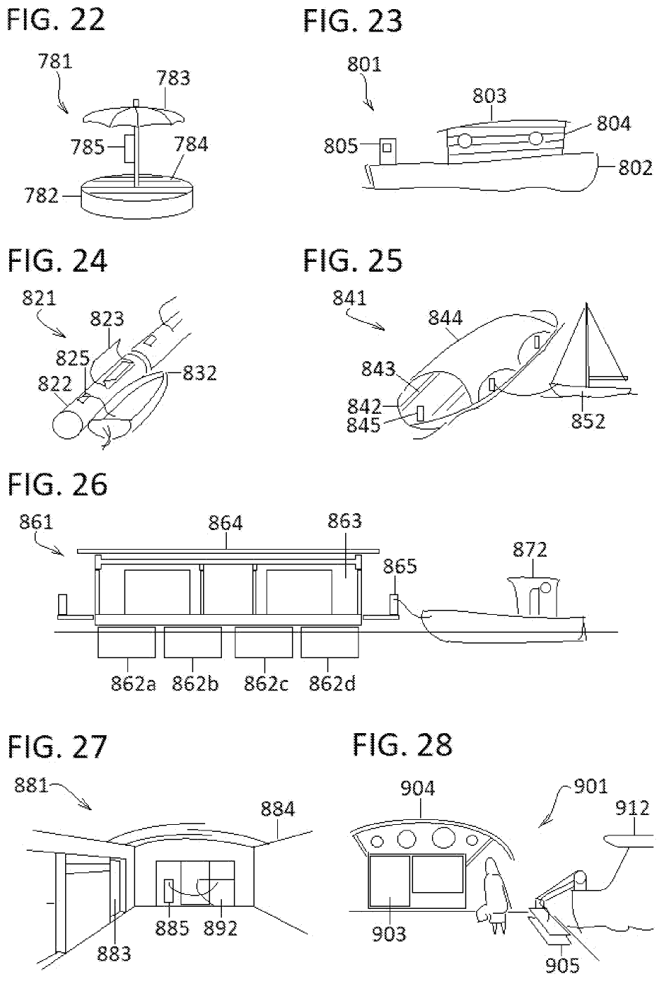

FIG. 22 is a perspective illustration of another embodiment of an offshore charging station (781) supported by a float (782) and comprising marine engineering constructions (784) [e.g. a platform], a charger with a charging interface (785) and providing facilities (783) [which can be recreational facilities]. The components of the OCS can be modularly scalable and exchangeable.

FIG. 23 is a side view of another embodiment of an offshore charging station (801) supported by a float (802) [which can be a boat hull] and comprising marine engineering constructions (804) [e.g. walls with a roof], a charger with a charging interface (805) and providing facilities (803) [which can be recreational and accomodation facilities]. The components of the OCS can be modularly scalable and exchangeable.

FIG. 24 is a perspective view of another embodiment of an offshore charging station (821) supported by a float (822) [which can be modularly scalable] and comprising a charger with a charging interface (825) for an offshore vessel (832) to be charged and providing facilities (823) [which can be an offshore rentable box and which can contain among others a second swappable rechargeable power source provided and recharged by the charging station (821)].

FIG. 25 is a perspective view of another embodiment of an offshore charging station (841) supported by a float (842) [which can be a hull type float], comprising marine engineering constructions (844) [e.g. a roof] and comprising chargers with charging interfaces (845) for an offshore vessel (852) to be charged and providing recreational facilities (843) [which can be a sports ground].

FIG. 26 is a cross sectional elevation view of another embodiment of an offshore charging station (861) supported by floats (862a, 862b, 862c, 862d) [which can be floating modules], comprising marine engineering constructions (864) [e.g. a skid mounted prefabricated modular unit] and comprising chargers with charging interfaces (865) for an offshore vessel (872) to be charged and providing facilities (863) [which can be a fisherman's marine].

FIG. 27 is an interior perspective view of another embodiment of an offshore charging station (881), comprising a marine engineering construction (884) [e.g. a marine building] and comprising chargers with charging interfaces (885) for an offshore vessel (892) to be charged and providing facilities (883) [which can be a marine hotel providing accomodation and a restaurant].

FIG. 28 is a perspective illustration of another embodiment of an offshore charging station (901), comprising a marine engineering construction (904) [e.g. a marine building comprising defined horizontal and vertical engineering constructions] and comprising chargers with charging interfaces (905) [e.g. wireless resonant inductive, resonant capacitive, resonant electromagnetic, resonant magnetodymamic] for an offshore vessel (912) to be charged/discharged and providing facilities (903) [which can be a fish market].

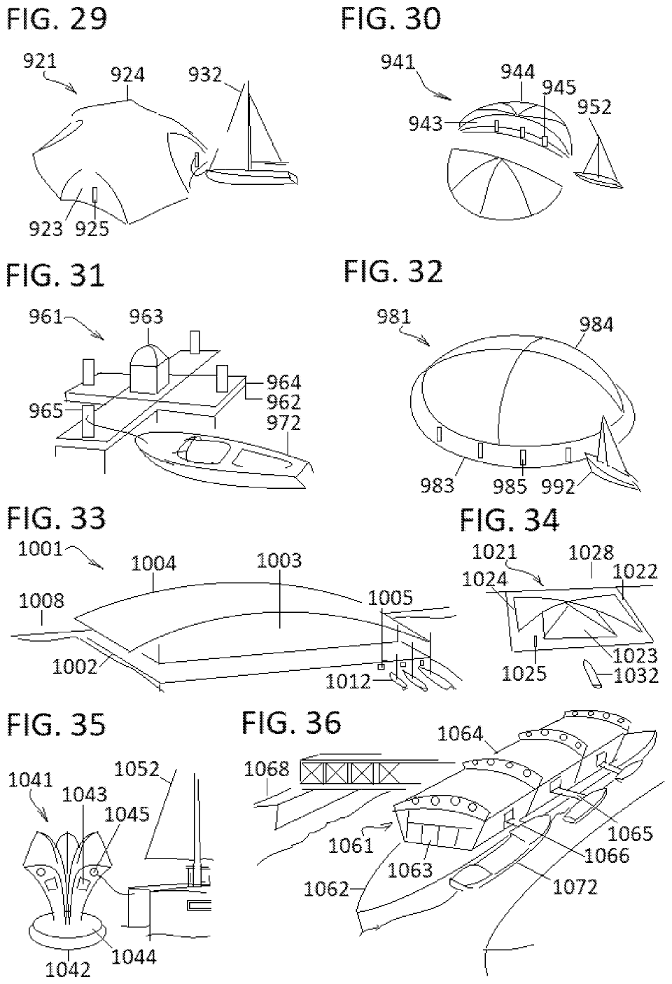

FIG. 29 is a perspective illustration of another embodiment of an offshore charging station (921), comprising an offshore charging station supporting construction (not shown) [which can be an anchored float], a marine engineering construction (924) [e.g. a prefabricated modularly scalable marine building comprising defined horizontal and vertical engineering constructions] and comprising chargers with charging interfaces (925) [e.g. wireless resonant inductive, resonant capacitive, resonant electromagnetic/as tought in my pending patent application titled Wireless electromagnetic energy transfer system of International Application No. PCT/IB2021/054328, resonant magnetodymamic] for an offshore vessel (932) to be charged/discharged and providing facilities (923) [which can be a marina with shops].

FIG. 30 is a perspective illustration of another embodiment of an offshore charging station (941), comprising an offshore charging station supporting construction (not shown) [which can be an anchored float], comprising a marine engineering construction (944) [e.g. a prefabricated modularly scalable marine building comprising defined horizontal and vertical engineering constructions] and comprising chargers with charging interfaces (945) [e.g. wireless resonant inductive, resonant capacitive, resonant electromagnetic, resonant magnetodymamic] for an offshore vessel at least partially electrically driven (952) to be charged/discharged and providing facilities (943) [which can be a marina with work-shops].

FIG. 31 is a perspective illustration of another embodiment of an offshore charging station (961), comprising an offshore charging station supporting construction (962) [which can be anchored floats], comprising a marine engineering construction (964) [e.g. a prefabricated modularly scalable platform on floats] and comprising chargers with charging interfaces (965) [e.g. wired/wireless] for an offshore vessel at least partially electrically driven (972) to be charged/discharged and providing a facility (963) [e.g. a vending machine].

FIG. 32 is a perspective illustration of another embodiment of an offshore charging station (981), comprising an offshore charging station supporting construction (not shown) [which can be an anchored float], comprising a marine engineering construction (984) [e.g. a prefabricated modularly scalable shell on floats] and comprising chargers with charging interfaces (985) [e.g. wired/wireless] for an offshore vessel at least partially electrically driven (992) to be charged/discharged and providing a recreational and accomodation facility (983) [e.g. a marina].

FIG. 33 is a perspective illustration of another embodiment of an offshore charging station (1001) situated off shore (1008) and comprising an offshore charging station supporting construction (1002) [which can be a wharf], comprising a marine engineering construction (1004) [e.g. a prefabricated modularly scalable shell with inner walls and floors based on pilotis] and comprising chargers with charging interfaces (1005) [e.g. wired/wireless which can be level adjustable] for offshore vessels at least partially electrically driven (1012) to be charged/discharged and providing various facilities (1003) [e.g. a marina with shops, restaurants, accomodation, etc.].

FIG. 34 is a perspective illustration of another embodiment of an offshore charging station (1021) situated off shore (1028) and comprising an offshore charging station supporting construction (1022) [which can be a pier], comprising a marine engineering construction (1024) [e.g. a double shell on a pontoon with inner walls and floors] and comprising chargers with charging interfaces (1025) [e.g. wired/wireless] for an offshore vessel at least partially electrically driven (1032) to be charged/discharged and providing a facility (1023) [e.g. a marina with a maritime museum and other recreational facilities, etc.].

FIG. 35 is a perspective illustration of another embodiment of an offshore charging station (1041) to be situated offshore and comprising an offshore charging station supporting construction (1042) [e.g. a float], a marine engineering construction (1044) [e.g. a platform] and comprising chargers with charging interfaces (1045) [e.g. wired/wireless] for an offshore vessel at least partially electrically driven (1052) to be charged/discharged and comprising facilities (1043) [e.g. the Internet access, a rentable box, a coffee shop, etc.].

FIG. 36 is a perspective illustration of another embodiment of an offshore charging station (1061) situated off shore (1068) and comprising a bottom rest supporting construction (1062) and a marine engineering construction (1064) [e.g. a building with walls, floors and a roof] and comprising chargers with charging interfaces (1063) [which can be coupled with dynamic mounts (1065) to cope with different vessel's charging interfaces levels] for an water vessel at least partially electrically driven (1072) to be charged/discharged and providing a shopping and recreational facility (1063) [e.g. a fast food restaurant chain drive thru facility, etc.].

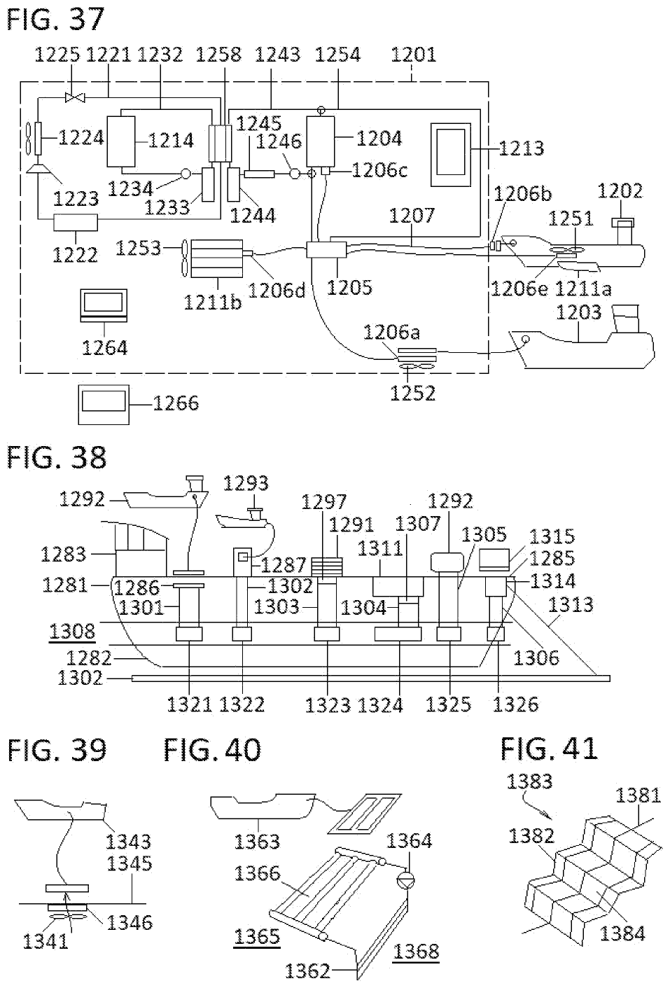

FIG. 37 is a schematic of another embodiment of an offshore charging station (1201) provided in an offshore charging system comprising water vessels at least partially electrically driven (1202, 1203) and the offshore charging station (1201) comprising a combined wired/wireless charger (1205) providing a wireless charging interface (1206a) [which can be an inductive charging pad], a fast DC charging interface (1206b), a DC charging interface (1206c) for a marine rechargeable power source (1204) [which can include a source management system] provided by the OCS (1201), another DC charging interface (1206d) for second swappable rechargeable power sources (1211b) provided by the OCS (1201) and an electromagnetic charging interface (1206e) for a first swappable rechargeable power source (1211a) provided by the water vessel (1202). The OCS (1201) can provide a power generator (1214) [which can be a (modularly configured) hydrogen power unit/which can include a hydrogen gas tank/providing fuel cells].

The OCS (1201) can provide a thermal management system which can be a liquid tempering system which can include loops [a first loop (1221) which can include a dryer/separator (1222), a compressor (1223), a condenser (1224), a thermostatic expansion valve (1225); a second loop (1232) which can provide a cooling system for the hydrogen fuel cell system (1214) and which can include a reservoir (1233) and a pump (1234); a third loop (1243) which can provide a tempering system for the marine rechargeable power source (1204) and which can include a reservoir (1244), a heater (1245), a pump (1246); a fourth loop (1254) which can provide a cooling system for the charger (1205) and a charging cable (1207) of the fast DC charging interface (1206b)].

The thermal management system can further be an air tempering system which can include fans (1251) for cooling the power transfer for a first swappable rechargeable power source (1211a); (1252) for cooling the wireless charging interface (1206a); (1253) for cooling the second swappable rechargeable power sources (1211b). All the loops (1221, 1232, 1243, 1254) can use the same heat exchanger (1258). The system can be controlled by an onboard controller (1264) which can optimalize loads, charging times, thermal management, which can perform controlling and monitoring functions and which can communicate with the vessels (1202, 1203) directly [e.g. via a wireless Local Area Network] and/or the system can be controlled by a central controller (1266) which can communicate with the onboard controller (1264) [e.g. via a satellite connection].

The OCS (1201) can provide facilities (1213) [e.g. a self-service box for the sale of frozen goods] which can be provided with an independent cooling system (not shown).

FIG. 38 is a schematic side view of another embodiment of an offshore charging station (1281) provided in an offshore charging system comprising water vessels at least partially electrically driven (1292), (1293) and the offshore charging station (1281) comprising a float (1282) [e.g. a hull], comprising a wireless charger (1286) provided at about a marine engineering construction (1285) [e.g. a deck], a DC charger (1287), a DC charger (1297) for second swappable rechargeable power sources (1291) provided by the OCS (1281), another DC charger (1307) for a marine rechargeable power source (1311) provided by the OCS (1281) which can provide a power generator (1292) [which can be a motor generator] and an OCS power source management system (1314) which can be statically/dynamically coupled with a charging cable (1313) with an offshore power source (1302).

The OCS (1281) can provide a thermal management system which can be a liquid tempering system which can include loops [a first loop (1301) which can cool the wireless charger (1286); a second loop (1302) which can cool the wired charger (1287); a third loop (1303) which can include a heater (not shown) and which can temper the second swappable rechargeable power sources (1291); a fourth loop (1304) which can include a heater (not shown) and which can temper the marine rechargeable power source (1311); a fifth loop (1305) which can cool the motor generator (1292) and a sixth loop (1306) which can cool the OCS power source management system (1314) and the charging cable (1313). All the loops (1301 to 1306) can be provided with a respective heat exchanger (1321 to 1326) which can provide a heat exchange with an offshore water (1308). The system can be controlled by an onboard controller (1315) which can optimalize loads, charging times, thermal management, etc. The system can be provided in an offshore charging system comprising an offshore power source (1312) [which can be a dynamic offshore charging system].

The OCS (1281) can provide maritime rescrue, shopping, work-shop and facilities (1283) which can be provided with an independent heating ventilation air conditioning (HVAC) system (not shown).

FIG. 39 is a schematic side view of a thermal management system of a wireless charging interface (1346) provided on a marine engineering construction (1345) [e.g. a floor, a wall, etc.] of an offshore charging station (not shown) which can be used in the proposed system. The OCS can provide a thermal management system which can be an air cooling module which can include a fan (1341) to cool the interface (1346) when charging an electric vessel (1343).

FIG. 40 is a perspective illustration of a thermal management system of a wireless charging interface (1366) provided on a marine engineering construction (1365) [or separately at a charging interface mount (not shown)] which can be used in the proposed offshore charging system. An OCS (not shown) can provide a thermal management system which can be a liquid tempering system comprising a pump (1364), a heat exchanger (1362) in a thermal contact with an offshore water (1368) to cool the interface (1366) when charging an electric vessel (1363).

FIG. 41 is a schematic of a thermal management system of a charging cable (1383) which can be used in the proposed offshore charging system. Charging wires (1381) can be provided with a watertight protective shock insulation layer (1382) [which can be made of a thermally conductive material] and with a cooling layer (1384) which can include coolant conducts. The surface layer (1382) can be corrugated or finned, etc. to enlarge the cooling area of air/liquid cooling.

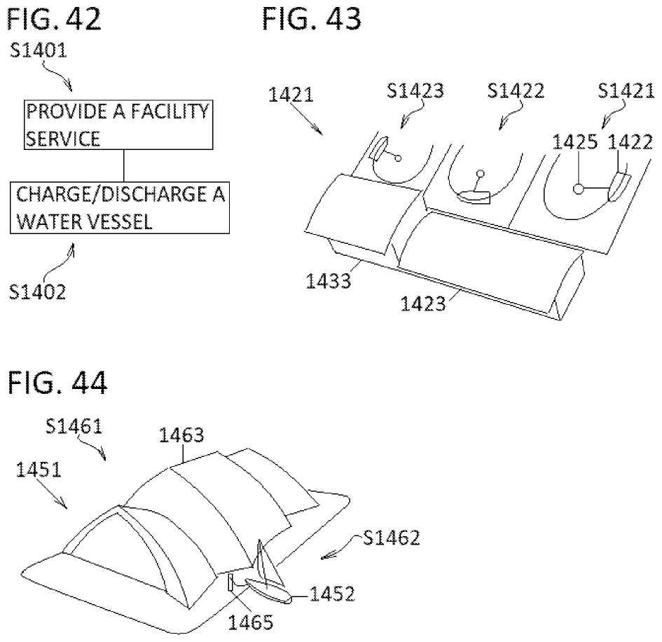

FIG. 42 is a process flowchart of an offshore servicing method, the process comprising the steps of: providing a facility service by an offshore charging station according to one of the claims 1 to 13 (S1401); providing charging/discharging a water vessel at least partially electrically driven (S1402), wherein the steps can be interchanged and/or repeated.

FIG. 43 is a perspective schematic illustration of an offshore servicing method comprising the step of charging/discharging a water vessel at least partially electrically driven (1422) at an offshore charging station (1421) comprising charging units (1425) [e.g. a combined charging unit with AC, DC and wireless charging interfaces (not shown)] (S1421); the step can be followed by providing service of a shopping/recreational facility (1423) [e.g. a restaurant service] (S1422); the step can be followed by providing service of an accomodation/recreational facility (1433) [e.g. a hotel service] (S1423). Others than shown services and in different order can be provided. The steps may overlap [e.g. charging/discharging overnight while providing catering, providing recreation and accomodation services for a crew and repairing a water vessel's lifeboat, i.e. providing a combined maritime rescue/work-shop facility service, etc.].

FIG. 44 is a perspective illustration of an offshore servicing method comprising the steps of providing a facility service by an offshore charging station (1451) according to one of the claims 1 to 13 (S1461) [e.g. in a multipurpose facilities building (1463); providing charging/discharging [e.g. by means of a charging unit (1465) with a charging interface (not shown)] water vessel at least partially electrically driven (1452) (S1462), wherein the steps (S1461, S1462) can be interchanged and/or repeated.

### Common Requirements

Offshore charging stations (OCSs) situated in seas or in oceans may be object of various tidal ranges varying from near zero to about 16 metres (53.5 feet) and averaging about 0.6 metres (2 feet) in the open ocean. In that case, level adjustable floats or level adjustable bottom rest supporting constructions may be designed to cope with a tidal range in a selected area for placement of the OCS. Passive (e.g. slack-line anchorages, sliding anchorages, etc.) and active anchorage systems (systems with active components) may be used to provide level adjustability.

The OCSs operated/temporarily operated under water level may provide atmospheric pressure in its inner space (e.g. in the container which can be filled with dry air, nitrogen, etc.) which may be advantageous for its electronic components or it may be kept at another pressure.

The OCSs may further include further components enhancing their functionality such as installation spaces, connecting boxes, electricity meters, main switches, input/output terminals, fuse distributions, etc. The electronic control and communication components may be housed in electromagnetically shielded spaces. All electrical and electronical equipment may be particularly protected against moisture, salt water and grid to prevent failure of power and electronic components. External controls may be suitably adapted to function in offshore conditions. Subsea plugs, isolation bushings, cathodic protection and special resistive materials and anticorrosive surface treatments may be used.

### Common Requirements on Offshore Charging Stations in Cold Areas

The offshore charging stations may be situated offshore in the Arctic, the Antarctic, subpolar and cold seas. In that case, components of the OCSs may be designed to be conform with cold/extremely cold/temporarily cold conditions. Offshore charging station supporting constructions may be specifically designed to be posed off shore on a solid base (e.g. ice). A special insulation of offshore power cables (which may be posed on ice), power cables may be provided. A special thermal insulation of marine rechargeable power sources (e.g. rechargeable power sources in containers) may be provided. Thermal management systems of the OCSs and the marine rechargeable power sources may require heating systems.

No limitations are intended others than as described in the claims. The present invention is not limited to the described exemplary embodiments. It should be noted that various modifications of the OCS can be made without departing from the scope of the invention as defined by the claims.

The elements described in this specification and the used terminology reflect the state of knowledge at the time of the filling of this application and may be developed in the future.

### INDUSTRIAL APPLICABILITY

The present invention may provide an offshore charging station (OCS) to water vessels at least partially electrically driven. Offshore charging may increase operational ranges of the vessels and reduce the necessary on-board battery capacity. Offshore charging may relieve port traffic.

An offshore power connection near ports may minimize air pollution from ships and improve an air quality in the port area if waiting ships are not forced to idle their internal combustion engines to provide themselves with electricity for auxiliary devices.

The OCS providing a bidirectional power flow may help to improve a performance of a power grid at peak load times and bring economic benefits.

A level adjustability of the OCSs and/or primary interfaces into levels under water level may protect them in case of a malevolent attack, bad weather conditions, may help to avoid conflicts with sea transport and fishing and may position the OCS and/or the primary interface in according to water vessels' charging/discharging requirements.

The OCS in a cloud-based communication system may bring efficiency, flexibility, lower costs and lower CO₂ emissions of an OCS management.

The OCS in a marine rechargeable power source system may provide a compact power source and may be utilised in the proposed swapping method.

Hydrogen powering system using renewable sources (arrays of solar cells, wind energy to electric energy converters, wave energy to electric energy converters, water currents energy to electric energy converters, tidal energy to electric energy converters) may provide a power reserve to be used for electricity production and supply by the OCS (e.g. in peak load times) or may be a principal power source.

The system may be functionally combined with a marine fuelling system and provide hydrogen fuel or another marine fuel for offshore applications.

Certain LNG fueled hybrid electric water vessels might not be allowed to bunker in a port. In such cases, a possibility of offshore charging and refuelling at a same station may be beneficial which similarly applies to hybrid water vessels using other marine fuels.

The proposed modularity may concern all elements of the OCS and can bring functional and financial benefits to the parties. Modular designs may use various degrees of modularity [e.g. component slottability, platform systems, holistic approach, etc.]. Modules may be catalogued.

The proposed swapping method and the offshore dynamic charging provided by the OCS may increase operational ranges of the water vessels at least partially electrically driven and may save time otherwise necessary for charging.

I claim:

1. An offshore charging station for a water vessel at least partially electrically driven, comprising: one or more chargers including or at least coupled with one or more charging interfaces to couple with said water vessel at least partially electrically driven to provide an unidirectional/bidirectional power flow, wherein at least one said charger is selected from the group consisting of AC chargers, DC chargers, inductive chargers, capacitive charges, magnetodynamic chargers, or combinations thereof; an offshore charging station supporting construction supporting mainly, but not exclusively said offshore charging station, characterised in that it further comprises: a facility operable at said offshore charging station, wherein at least one said facility is selected from the group consisting of maritime rescue facilities, shopping facilities, work-shop facilities, recreational facilities, accommodation facilities, or combinations thereof.

2. The offshore charging station according to claim 1, configured to enable static/dynamic wireless charging/discharging using a wireless charging system, wherein at least one said wireless charging system is selected from the group consisting of inductive charging systems, capacitive charging systems, magnetodynamic charging systems, or combinations thereof.

3. The offshore charging station according to claim 1, further comprising: one or more charging interface mounts, wherein at least one said charging interface mount is selected from the group consisting of static mounts, dynamic arms, robotic arms, drones, robots, dynamic mounts, floats, level adjustable floats, bottom rest supporting constructions, level adjustable bottom rest supporting constructions, or combinations thereof, wherein said static mount holds said charging interface in a position, and wherein said dynamic arm, said robotic arm, said drone, said robot, said dynamic mount are able to delocalize said charging interface to enable charging/discharging, and wherein said float, said level adjustable float, said bottom rest supporting construction, said level adjustable bottom rest supporting construction support said charging interface.

4. The offshore charging station according to claim 1, further comprising:
a marine engineering construction supporting at least one element of said offshore charging station and further characterised by its constructional type, wherein at least one said constructional type is selected from the group consisting of platforms, walls, columns, beams, roofs, or combinations thereof.

5. The offshore charging station according to claim 1, further comprising: an operational security control element operable at said offshore charging station, wherein at least one said operational security control element is selected from the group consisting of security cameras, security control circuits, control elements operable to interrupt power supplies, or combinations thereof.

6. The offshore charging station according to claim 1, further comprising: a thermal management system to thermally manage charging/discharging, wherein at least one said thermal management system is selected from the group consisting of air tempering systems, liquid tempering systems, liquid tempering systems using offshore water as a thermal medium, or combinations thereof.

7. The offshore charging station according to claim 1, further comprising: a marine attachment operable at said offshore charging station, wherein at least one said marine attachment is selected from the group consisting of antennas, navigational aid constructions, recording instruments, mooring attachments, or combinations thereof.

8. The offshore charging station according to claim 1, further comprising: a payment terminal enabling at least one payment selected from the group consisting of online payments, cash payments, mobile payments, chip card payments, magnetic stripe card payments, or combinations thereof, wherein an acceptation of said payment via said payment terminal is in relation with functioning of said charger and/or of said facility.

9. The offshore charging station according to claim 1, wherein said offshore charging station is provided as part of an offshore charging system characterised in that it comprises: said water vessel at least temporarily coupled to at least one of said one or more charging interfaces; an offshore power cable to provide said offshore charging station with an unidirectional/bidirectional power flow and coupled with a power source, wherein at least one said power source is selected from the group consisting of onshore power sources, offshore power sources, arrays of solar cells, fuel cells, wind energy to electric energy converters, wave energy to electric energy converters, water currents energy to electric energy converters, tidal energy to electric energy converters, motor generators, smart grids, or combinations thereof, and wherein at least one said offshore charging station supporting construction is selected from the group consisting of floats, level adjustable floats, bottom rest supporting constructions, level adjustable bottom rest supporting constructions, or combinations thereof.

10. The offshore charging station according to claim 1, characterised in that it provides at least one data transmission selected from the group consisting of wired data transmissions, wireless data transmissions, or combinations thereof, wherein said data transmission is in relation with charging/discharging said water vessel at least partially electrically driven.

11. The offshore charging station according to claim 1, wherein said offshore charging station is provided as part of a cloud-based communication system, characterised in that it comprises: one or more communication nodes, wherein at least one said communication node is selected from the group consisting of operators, said offshore charging stations, said water vessels at least partially electrically driven, marine rechargeable power sources, or combinations thereof; a cloud, wherein said communication node is in wired/wireless communication with said cloud, and wherein said marine rechargeable power source is characterised in that it comprises: a rechargeable power source; a source management system to manage charging/discharging said rechargeable power source; a container containing at least said rechargeable power source, wherein at least one said container is selected from the group consisting of buoyant containers, nonbuoyant containers, mobile containers, or combinations thereof, said marine rechargeable power source further characterised in that it provides at least one data transmission selected from the group consisting of wired data transmissions, wireless data transmissions, or combinations thereof, wherein said data transmission is in relation with charging/discharging said rechargeable power source and/or said water vessel at least partially electrically driven and/or with a power transfer between said water vessel at least partially electrically driven and said rechargeable power source.

12. The offshore charging station according to claim 1, wherein said offshore charging station is provided as part of a hydrogen powering system, characterised in that it comprises: a hydrogen production system to produce hydrogen in a functional connection with said offshore charging station, wherein at least one said hydrogen production system is selected from the group consisting of electrolysis systems, hydrocarbons reforming systems, alcohols reforming systems, sugars reforming systems, chemical processing systems, biological processing systems, biomass processing systems, thermal processing systems, photo processing systems, metal and water systems, or combinations thereof; a hydrogen storage system to store at least partially hydrogen produced by said hydrogen production system, wherein at least one said hydrogen storage system is selected from the group consisting of compressed gas systems, liquified gas systems, chemical systems, electrochemical systems, physi-sorption systems, nanomaterial systems, intercallation in metals systems, intercallation in hydrides systems, inorganic gaseous systems, inorganic liquids systems, inorganic solids systems, organic gaseous systems, organic liquids systems, organic solids systems, or combinations thereof.

13. The offshore charging station according to claim 1, wherein said offshore charging station is provided as part of a marine fuelling system to provide a marine fuel in a functional connection with said offshore charging station, the system characterised in that it comprises: a fuel dispenser; a fuel storage system; a fuelling line system, wherein said fuelling line system transfers said marine fuel from said fuel storage system to said fuel dispenser.

14. An offshore swapping method, the method comprising the steps of:
bringing by a water vessel at least partially electrically driven a first marine rechargeable power source within an operational range of an offshore charging station according to one of the preceding claims;
swapping said first marine rechargeable power source for a second marine rechargeable power source provided by said offshore charging station.

15. An offshore servicing method, the method comprising the steps of:
providing a facility service by an offshore charging station according to one of the claims 1 to 13;
providing charging/discharging said water vessel at least partially electrically driven, wherein the steps can be interchanged and/or repeated.
